(19) United States
(12) Patent Application Publication
(10) Pub. No.: US 2002/0086728 A1
(43) Pub. Date: Jul. 4, 2002

(54) Game feature for a gaming machine

(76) Inventors: Nicholas Luke Bennett, Lane Cove (AU); Philippa Graham, Lane Cove (AU)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/001,433

(22) Filed: Oct. 17, 2001

(30) Foreign Application Priority Data
Oct. 17, 2000 (AU) PR0806

(51) Int. Cl. A63F 13/00

(52) U.S. Cl. 463/25

(57) ABSTRACT

A gaming machine has a display means and a game control means arranged to control images displayed on the display means. The game control means are arranged to play an underlying game wherein one or more random events are caused to be displayed on the display means and, if a predefined winning event occurs, the machine awards a prize. On the occurrence of a predetermined triggering event, a representation of a three-dimensional object typically a sphere is displayed. The object defines a representation of a three-dimensional surface area which is divided up into a number of separate zones and is animated to simulate rotation, turning, spinning or other movement. During the simulated movement zones may disappear from view on the display and reappear on the display. After a period the object simulates coming to rest. The machine including means for indicating that one of the zones is a prize outcome, when the representation of the object has come to rest. In one embodiment the sphere is the globe.

### FIELD OF THE INVENTION

This invention relates to a gaming machine. More particularly, the invention relates to a gaming machine and to an improvement to a game played on such a gaming machine.

### BACKGROUND TO THE INVENTION

Players who regularly play gaming machines quickly tire of particular games and therefore it is necessary for manufacturers of these machines to develop innovative game features which add interest to the games. In so doing, it is hoped to keep players amused and therefore willing to continue playing the game as well as to attract new players.

Also, with the growth that has occurred in the gaming machine market, there is intense competition between manufacturers to supply various existing and new venues. When selecting a supplier of gaming machines, the operator of a venue will often pay close attention to the popularity of various games with their patrons. Therefore, gaming machine manufacturers are keen to devise games which are popular with the players as a mechanism for improving sales, retaining customers and attracting new customers.

Some gaming machines provide secondary games to increase player interest which may involve spinning wheels or the like such as U.S. Pat. No. 5,848,932. However spinning wheels are common in the field of gaming generally and it would be preferable to provide a more player-stimulating alternative.

### SUMMARY OF THE INVENTION

In a first aspect of the present invention, there is provided a gaming machine having a display means and a game control means arranged to control images displayed on the display means, the game control means being arranged to play an underlying game wherein one or more random events are caused to be displayed on the display means and, if a predefined winning event occurs, the machine awards a prize, the gaming machine being characterised in that on the occurrence of a predetermined triggering event, a representation of a three-dimensional object which object defines a representation of a three-dimensional surface area which is divided up into a number of separate zones, is animated to simulate rotation, turning, spinning or other movement, during which simulated movement zones may disappear from view on the display and reappear on the display, wherein after a period the object simulates coming to rest, the machine including means for indicating that one of the zones is a prize outcome, when the representation of the object has come to rest.

Most typically, the three-dimensional object is a sphere, ball, or the like. However cubes, pyramids, cylinders or the like could be used.

Providing a sphere or the like as a feature of the game increases player interest as the manner of presentation of potential prizes, bonuses, jackpots etc on a sphere is novel and is inherently more interesting than a spinning wheel as the prizes etc are hidden behind the sphere, for part of the time.

The sphere may be displayed on the occurrence of a predefined event. In particular, the sphere feature may be provided as a secondary feature associated with any underlying or base game and may be triggered by any standard triggering method, for example the occurrence of a predetermined combination of symbols on the base game or by a random selection at the gaming machine. If the gaming machine is linked to a bank of gaming machines the trigger may be by means of a random selection by a central controller linked to the bank of gaming machines. The sphere will then appear on the same display screen as the basic game appeared on.

The random trigger may be dependent upon the amount of money that has been bet on the current game, or accumulated across the bank of linked gaming machines, if the gaming machine is so linked.

In an alternative embodiment the sphere is displayed on its own dedicated secondary screen and is displayed at all times while the basic game is being played. The sphere may just remain idle while the basic game is being played until the triggering event occurs. Alternatively the sphere feature may spin after each game of the underlying game so that the triggering event is simply a play or spin of the underlying game.

Various types of prizes may be awarded using the feature of the present invention including linked progressive jackpots, fixed or accumulated prizes, or bonuses relating to the base game being played such as repeat wins, free games, feature games, win multipliers and so on. The invention is not limited by the particular prizes displayed on the segments or zones of the sphere. Intermediate prizes may be provided within the sphere feature such as allowing a second spin of the sphere and the like.

In one embodiment, the sphere is divided in segments similar to segments of an orange. A pointer may be provided to indicate the winning segment. Alternatively, the front most segment may be the winning segment when the spinning sphere comes to rest. The fixed axis is most typically a vertical or horizontal axis.

In one particularly preferred embodiment, the representation may be animated so that after the sphere comes to rest, the winning segment simulates falling forwards out of the sphere in order to reveal a prize on a previously hidden face of the segment This type of animation greatly increases player interest in the game.

In one variant, of this embodiment, none of the zones/segments of the sphere indicate a prize at all. Instead, the segments are coloured differently from one another. When the sphere stops spinning the segment which is indicated will be animated to show the segment opening out to reveal the prize, In a variant of this concept the 3-D object could open up in other ways. For example the object may be a cube and the cube may open like a box to reveal a prize inside. The prize may sit inside the object. For example if an egg shaped object were used the egg may crack open to reveal a prize.

The sphere does not have to spin about its axis but may simply turn about its centre, in which case the sphere would not be divided into segments, but may define flattened areas similar to a golf ball or parts of a soccer ball and those areas may display prize indicia. A simulation of a spotlight or some other pointer could be used to highlight an area on the sphere that will be the location of the prize outcome when the sphere comes to rest.

The movement of the sphere may be shown to be caused by an external event. For example, an animation of a clown or gymnast may be shown running on top of the sphere.

In one particular preferred embodiment, the sphere takes the form of a globe showing the earth. Prizes are not indicated on the surface of the globe. Instead, the country or location at which the sphere comes to rest, would be the theme for a further feature game. For example, if the sphere stopped on Australia, a second screen feature would commence with an Australian theme. If this sphere stopped on France, free games may commence with French themed symbols on the reel strips Landing on an ocean may result on an underwater theme feature, landing on a snowy mountain may result in a skiing theme feature, landing on a fault line may result in an volcano theme feature, whereas landing on the border between two countries or locations might result in the sphere being spun again.

### BRIEF DESCRIPTION OF THE DRAWINGS

The invention is now described by way of example with reference to the accompanying diagrammatic drawings in which:

FIG. 1 shows a three dimensional view of a gaming machine, in accordance with the invention;

FIG. 2 shows a block diagram of a control circuit of the gaming machine;

FIG. 3 shows a screen display which appears on a gaming machine following the triggering of the game feature of the present invention;

FIG. 4 shows an alternative screen display;

FIG. 5 shows a feature similar to FIG. 3;

FIG. 6 shows a subsequent feature of the display of FIG. 5: and

FIG. 7 illustrates an alternative screen display of a globe.

### DETAILED DESCRIPTION OF THE PREFERRED EMBODIMENTS AND EXAMPLES

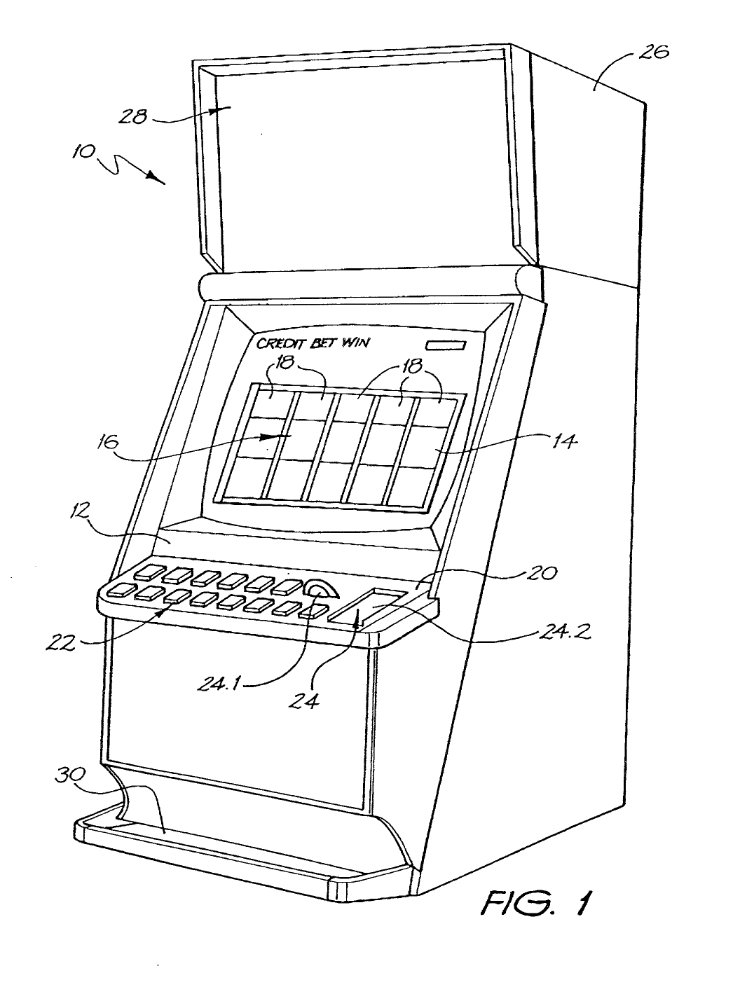

In FIG. 1, reference numeral 10 generally designates a gaming machine, including a game, in accordance with the invention. The machine 10 includes a console 12 having a video display unit 14 on which a game 16 is played, in use. The preferred form of a base game of the game 16 is a spinning reel game which simulates the rotation of a number of spinning reels 18. It will, however, be appreciated that the invention is equally applicable to other types of base games such as card games, pachinko or ball games such as Bingo or Keno, or any type of gambling game. A midtrim 20 of the machine 10 houses a bank 22 of buttons for enabling a player to play the game 16. The midtrim 20 also houses a credit input mechanism 24 including a coin input chute 24.1 and a bill collector 24.2.

The machine 10 includes a top box 26 on which artwork 28 is carried. The artwork 28 includes paytables, details of bonus awards, etc.

A coin tray 30 is mounted beneath the console 12 for cash payouts from the machine 10.

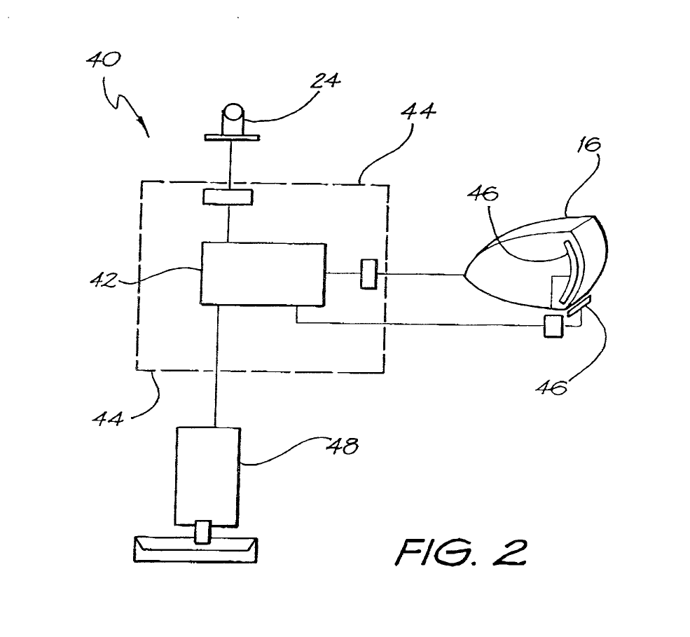

Referring now to FIG. 2 of the drawings, a control means or control circuit 40 is illustrated. A program which implements the game and user interface is run on a processor 42 of the control circuit 40. The processor 42 forms part of a controller 44 which drives the screen of the video display unit 14 and which receives input signals from sensors 46, The sensors 46 include sensors associated with the bank 22 of buttons and touch sensors mounted in the screen 16. The controller 44 also receives input pulses from the mechanism 24 indicating that a player has provided sufficient credit to commence playing. The mechanism 24 may, instead of the coin input chute 24.1 or the bill collector 24.2, or in addition thereto, be a credit card reader (not shown) or any other type of validation device.

Finally, the controller 44 drives a payout mechanism 48 which, for example, may be a coin hopper for feeding coins to the coin tray 30 to pay a prize once a predetermined combination of symbols carried on the reels 18 appears on the screen 16 or some other prize winning event occurs.

The player plays the base game, which, as discussed above in the described embodiment, is a video reel game (a video simulation of spinning reels). The novel game feature of the present invention relates to the appearance of a spinning sphere or the like, which spins to “reveal” or indicate prizes, jackpots or bonus features. In the preferred embodiment, this is done as a display on a video screen, with the display being animated to make it appear as if the sphere is spinning.

FIG. 3 shows a screen display showing a typical sphere 50. The sphere is divided up into a number of zones in the form of segments 50.1, 50.2 . . . 50.5 . . . 50.n which display prize indicia. In the present embodiment shown in FIG. 3 the prize indicia include 100 credits, 1000 credits, 50 credits, and unspecified bonus and 200 credits. Obviously, as the sphere is three dimensional, there are some segments which are not visible to the player, as they are on the reverse or invisible side of the sphere. They will only become visible, when the sphere starts spinning.

The appearance of the sphere may be triggered by any standard triggering method and typically arises as a secondary feature which occurs during the playing of a base game, The sphere may for example, be triggered upon the occurrence of a predetermined combination of symbols during the base game or by random selection either at the gaming machine or if the gaming machine is linked to a bank of gaming machines by a random selection by a central controller linked to that bank. The random trigger may be dependent upon the amount of money that has been bet on the current game or played on the gaming machine or accumulated across the bank of linked gaming machines. However, the particular trigger is not critical to the present invention.

Any types of prizes may be awarded from the sphere feature, including linked progressive jackpots, fixed or accumulated prizes or bonuses related to the base game being played such as repeat wins, free games, win multipliers and the like. The sphere may provide intermediate prizes such as another spin of the sphere. The game and the prizes awarded are not critical to the invention.

In the embodiment shown in FIG. 3, where the sphere spins around a fixed vertical axis, either a pointer of some sort is provided to indicate the winning segment, or alternatively, the front most segment may always be the winning segment when the spinning sphere comes to rest. Again, the manner of indicating the winning segment is not critical. In the example shown in FIG. 3, the sphere comes to rest and the foremost segment 50.3 is the winning segment, and the machine pays a prize of 50 credits.

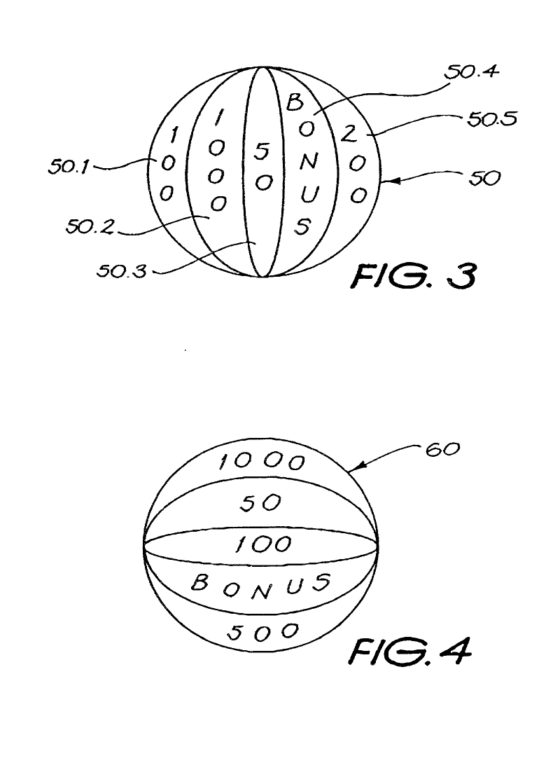

FIG. 4 shows an alternative version, in which the sphere 60 spins around a horizontal, rather than a vertical, axis.

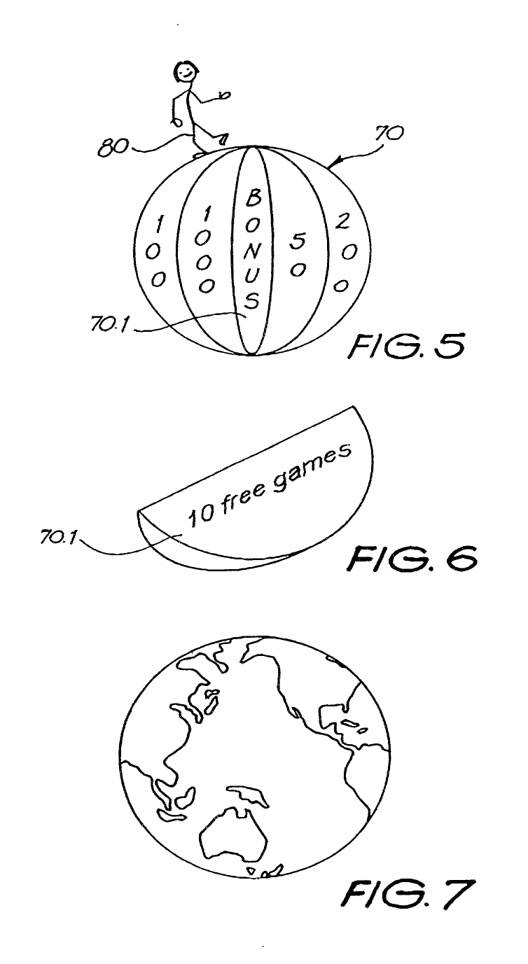

In one further embodiment, the segment opens up to reveal bonus prizes. Thus, FIG. 5 shows a sphere 70 similar to that shown in FIG. 3 having come to rest showing “bonus” 70.1 as a prize outcome. In this case, the sphere is animated such that the bonus segment 70.1 drops out of the sphere and on the sides of the segment, as shown in FIG. 6, are written the bonus prize) which in the embodiment shown, is 10 free games.

In an alternative embodiment, prize indicia are not shown on the segments of the sphere and the segments are simply coloured. When the sphere stops spinning, the appropriate segment simply opens out in the manner of the bonus feature to reveal the prize.

In one variant of the invention the movement of the sphere is shown to be caused by an external event. For example, an animation of a person 80 (refer to FIG. 5) such as clown or gymnast or the like may be shown running on top of the sphere.

The invention is not restricted to the sphere spinning on a vertical or horizontal axis. The sphere may for example, spin about its centre in which case the sphere would not be divided into segments but could simply provide prize areas covering the surface of the sphere similar to the sections of a soccer ball or the surface of a golf ball. A spotlight or some other pointer could be used to indicate which particular zone of the sphere will define the prize outcome when the sphere comes to rest.

In an alternative embodiment the sphere is displayed at all times on its own dedicated secondary screen while the basic game is being played. The sphere may just remain idle while the basic game is being played attracting players until the triggering event occurs. Alternatively the sphere feature may spin after each game of the underlying game so that the trigger is simply a play or spin of the underlying game.

In a yet further embodiment, the sphere may be a globe, see FIG. 7 representing the earth. In this embodiment, instead of prizes being displayed on the various countries of the world, the country or location at which the sphere comes to rest, is a theme for a further game feature. For example, if the sphere stops on Australia, a second screen feature could commence with an Australian theme. Similarly, if the sphere indicates that France is the outcome, free games may commence with a French theme with French themed symbols on the reel strips of the underlying game, in the case that the underlying game is a video reel poker game. In similar manner, landing on an ocean may result in a screen feature having an underwater theme feature, landing on a snowy mountain may result in a skiing theme feature, landing on a fault line may result in an volcano theme feature. If a prize outcome is a border between two countries or locations, the sphere might be spun again.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The claims defining the invention are as follows:

1. A gaming machine having a display means and a game control means arranged to control images displayed on the display means, the game control means being arranged to play an underlying game wherein one or more random events are caused to be displayed on the display means and, if a predefined winning event occurs, the machine awards a prize, the gaming machine being characterised in that on the occurrence of a predetermined triggering event, a representation of a three-dimensional object which object defines a representation of a three-dimensional surface area which is divided up into a number of separate zones, is animated to simulate rotation, turning, spinning or other movement, during which simulated movement, zones may disappear from view on the display and reappear on the display, wherein after a period the object simulates coming to rest, the machine including means for indicating that one of the zones is a prize outcome, when the representation of the object has come to rest.

2. A gaming machine as claimed in claim 1 wherein the three-dimensional object is a sphere, ball, or the like.

3. A gaming machine as claimed in claim 1 wherein the three-dimensional object is a cube, a pyramid, or a cylinder.

4. A gaming machine as claimed in claim 1 wherein the three-dimensional object is provided as a secondary feature game to the underlying game and is displayed on display means and animated on the occurrence of a predefined event in the underlying game.

5. A gaming machine as claimed in claim 4 wherein the predefined event for the appearance of the secondary feature game is the occurrence of a predetermined combination of symbols in the underlying game.

6. A gaming machine as claimed in claim 1 wherein the three-dimensional object is provided as a secondary feature game to the underlying game and is displayed on display means and animated on the occurrence of a trigger event, wherein the trigger event is generated by a random selection performed by the game control means.

7. A gaming machine as claimed in claim 1 wherein the three-dimensional object is provided as a secondary feature game to the underlying game and is displayed on display means and animated on the occurrence of a trigger event, wherein the gaming machine is linked to a bank of gaming machines and the trigger event is by means of a random selection by a central controller linked to the bank of gaming machines.

8. A gaming machine as claimed in claim 7 wherein the trigger event is dependent upon the amount of money that has been bet on the current game, or accumulated across the bank of linked gaming machines.

9. A gaming machine as claimed in claim 1 wherein the three-dimensional object is displayed on its own dedicated secondary screen and is displayed at all times while the underlying game is being played.

10. A gaming machine as claimed in claim 9 wherein the three-dimensional object remains idle while the underlying game is being played on the gaming machine until a triggering event occurs.

11. A gaming machine as claimed in claim 9 wherein the three-dimensional object is animated after each game of the underlying game.

12. A gaming machine as claimed in claim 2 wherein the three-dimensional object is a sphere which is divided into segments and which spins about a fixed axis when animated.

13. A gaming machine as claimed in claim 12 wherein a pointer means is provided to indicate the winning segment after the sphere has stopped moving.

14. A gaming machine as claimed in claim 12 wherein a front most segment is the winning segment when the spinning sphere comes to rest.

15. A gaming machine as claimed in claim 12 wherein the fixed axis is a vertical or horizontal axis.

16 A gaming machine as claimed in claim 12 wherein the representation is animated such that after the sphere comes to rest, the winning segment simulates falling forwards out of the sphere in order to reveal a prize on a previously hidden face of the segment.

17 A gaming machine as claimed in claim 12 wherein the segments are coloured differently from one another and when the sphere stops spinning the segment which is indicated will be animated to show the segment opening out to reveal the prize.

18 A gaming machine as claimed in claim 1 wherein the three-dimensional object is a cube which opens like a box to reveal a prize inside when the cube stops simulating movement.

19. A gaming machine as claimed in claim 1 wherein a prize for the secondary games sits inside the three-dimensional object which open to reveal a prize when the three-dimensional object stops simulating movement.

20. A gaming machine as claimed in claim 12 wherein the three-dimensional object is a sphere wherein the zones are defined by flattened areas which display prize indicia and wherein a simulation of a spotlight or some other pointer means is provided to highlight an area on the sphere that will be the location of the prize outcome when the sphere comes to rest.

21. A gaming machine as claimed in any preceding claim wherein an external event is shown which is simulated as causing the movement of the three-dimensional object.

22. A gaming machine as claimed in claim 1 wherein the three-dimensional object is a the sphere which takes the form of a globe illustrating locations on the earth.

23. A gaming machine as claimed in claim 22 wherein the location is a country.

24 A gaming machine as claimed in claim 22 or claim 23 wherein the location at which the sphere comes to rest provides a theme for a further feature game.

25. A gaming machine having a display means and a game control means arranged to control images displayed on the display means, the game control means being arranged to play an underlying game wherein one or more random events are caused to be displayed on the display means and, if a predefined winning event occurs, the machine awards a prize, the gaming machine being characterised in that on the occurrence of a predetermined triggering event in the underlying game, a secondary feature game is initiated in which a representation of a sphere defining a representation of a three-dimensional sperical surface area which is divided up into a number of separate zones, is displayed and animated to simulate movement, zones may disappear from view on the display and reappear on the display, wherein after a period the object simulates coming to rest, the machine including means for indicating that one of the zones is a prize outcome, when the representation of the object has come to rest.
